(19) United States
(12) Patent Application Publication
(10) Pub. No.: US 2016/0242185 A1
(43) Pub. Date: Aug. 18, 2016

(54) POWER ALLOCATION FOR NON-SCHEDULED TRANSMISSION OVER DUAL CARRIER HSUPA

(71) Applicant: QUALCOMM Incorporated, San Diego, CA (US)

(72) Inventors: Omesh Kumar Handa, Carlsbad, CA (US); Yi Zhang, San Diego, CA (US); Anoop Ramakrishna, San Diego, CA (US); Murali Menon, Acton, MA (US); Yuan Wang, San Diego, CA (US); Yunsong Mu, La Jolla, CA (US)

(21) Appl. No.: 14/858,150

(22) Filed: Sep. 18, 2015

Related U.S. Application Data
(60) Provisional application No. 62/117,406, filed on Feb. 17, 2015.

(51) Int. Cl. H04W 72/04

(52) U.S. Cl. CPC H04W 72/0473; H04W 72/0486

(57) ABSTRACT

A user equipment (UE) determines a first transmit power parameter for a primary carrier and a secondary carrier of a multi-carrier uplink, based on a first data power allocated for a first data type to be transmitted on the multi-carrier uplink. The UE determines a first maximum enhanced uplink transport format combination indicator (E-TFCI) for the primary carrier and the secondary carrier based on the first transmit power parameter. If the primary carrier or the secondary carrier has data of a second data type for transmission, the UE determines a second data power allocated for the first data type utilizing the first maximum E-TFCI as a reference E-TFCI. If a difference in value between the first data power and the second data power is less than a threshold value, the UE utilizes the first transmit power parameter for transmitting data on the primary carrier and the secondary carrier.

### PRIORITY CLAIM

This application claims priority to and the benefit of provisional patent application No. 62/117,406 filed in the United States Patent and Trademark Office on Feb. 17, 2015, the entire content of which is incorporated herein by reference.

### TECHNICAL FIELD

The technology discussed below relates generally to wireless communication systems, and more particularly, to multi-carrier high speed uplink packet access (MC-HSUPA).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

The standards that define HSPA include HSDPA (high speed downlink packet access) and HSUPA (high speed uplink packet access, also referred to as enhanced uplink or EUL). DC-HSUPA (Dual Carrier HSUPA or Dual Cell HSUPA) is a carrier aggregation technique for improving uplink performance. DC-HSUPA combines two uplink carriers into a larger data pipe with joint scheduling of uplink traffic across the two carriers or frequencies. It allows wireless devices to make use of instantaneous or real-time spare capacity available on either carrier, thus achieving multiplexing gain and load balancing. The benefit is a significant efficiency improvement which leads to higher system capacity.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method for operating a user equipment (UE) to determine power allocation for a multi-carrier uplink in wireless communication. The UE determines a first transmit power parameter for a primary carrier and a secondary carrier of a multi-carrier uplink, based on a first data power allocated for a first data type to be transmitted on the multi-carrier uplink. The UE further determines a first maximum enhanced uplink transport format combination indicator (E-TFCI) for the primary carrier and the secondary carrier based on the first transmit power parameter. If the primary carrier or the secondary carrier has data of a second data type for transmission, the UE determines a second data power allocated for the first data type utilizing the first maximum E-TFCI as a reference E-TFCI. If a difference in value between the first data power and the second data power is less than a threshold value, the UE utilizes the first transmit power parameter for transmitting data on the primary carrier and the secondary carrier. The first data power may be the power allocated for non-scheduled data (a first data type) to be transmitted on the multi-carrier uplink. The second data type may be scheduled data.

Another aspect of the disclosure provides an apparatus for multi-carrier wireless communication. The apparatus includes means for determining a first transmit power parameter for a primary carrier and a secondary carrier of a multi-carrier uplink, based on a first data power allocated for a first data type to be transmitted on the multi-carrier uplink. The apparatus further includes means for determining a first maximum enhanced uplink transport format combination indicator (E-TFCI) for the primary carrier and the secondary carrier based on the first transmit power parameter. The apparatus further includes means for if the primary carrier or the secondary carrier has data of a second data type for transmission, determining a second data power allocated for the first data type utilizing the first maximum E-TFCI as a reference E-TFCI. The apparatus further includes means for if a difference in value between the first data power and the second data power is less than a threshold value, utilizing the first transmit power parameter for transmitting data on the primary carrier and the secondary carrier.

Another aspect of the disclosure provides an apparatus for multi-carrier wireless communication. The apparatus includes a communication interface configured to utilize a multi-carrier uplink including a primary carrier and a secondary carrier. The apparatus further includes a memory including code for causing the apparatus to perform multi-carrier uplink communication, and at least one processor operatively coupled to the communication interface and the memory. The at least one processor when configured by the code includes a first data power block, a transport format selector, and a second data power block. The first data power block is configured to determine a first transmit power parameter for a primary carrier and a secondary carrier of the multi-carrier uplink, based on a first data power allocated for a first data type to be transmitted on the multi-carrier uplink. The transport format selector is configured to determine a first maximum enhanced uplink transport format combination indicator (E-TFCI) for the primary carrier and the secondary carrier based on the first transmit power parameter. The second data power block is configured to if the primary carrier or the secondary carrier has data of a second data type for transmission, determine a second data power allocated for the first data type utilizing the first maximum E-TFCI as a reference E-TFCI. The second data power block is further configured to if a difference in value between the first data power and the second data power is less than a threshold value, utilize the first transmit power parameter for transmitting data on the primary carrier and the secondary carrier.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a telecommunications system in accordance with aspects of the disclosure.

FIG. 2 is a block diagram illustrating an example of a hardware implementation for an apparatus employing a processing system in accordance with aspects of the disclosure.

FIG. 3 is a block diagram illustrating an example of a Node B in communication with a user equipment (UE) in a wireless communications system in accordance with aspects of the disclosure.

FIG. 4 is a diagram illustrating an example of an access network in accordance with aspects of the disclosure.

FIG. 5 is a diagram illustrating an example of a radio protocol architecture for the user and control plane in accordance with aspects of the disclosure.

FIG. 6 is a diagram illustrating a UE capable of performing DC-HSUPA communications in accordance with aspects of the disclosure.

FIG. 7 is a diagram illustrating an example of the relationship between the pilot power ratio (T/P) and E-TFCI in accordance with an aspect of the disclosure.

FIG. 8 is a diagram illustrating a method for iteratively determining the power allocation and EUL transport format combination indicator (E-TFCI) selection for a dual-carrier uplink in accordance with an aspect of the disclosure.

FIGS. 9-10 illustrate a flow chart of a procedure for determining the power allocation and EUL transport format combination indicator (E-TFCI) selection on primary and secondary DC-HSUPA carriers when non-scheduled bits are transmitted in accordance with an aspect of the disclosure.

FIG. 11 is a flow chart illustrating a procedure for determining the T/P or NRPM of scheduled data transmissions of a dual-carrier uplink in accordance with an aspect of the disclosure.

FIG. 12 is a flow chart illustrating a procedure for determining a maximum E-TFCI for a dual-carrier uplink based on T/P or NRPM in accordance with an aspect of the disclosure.

FIG. 13 is a flow chart illustrating a procedure for determining a power allocation of non-scheduled data for a dual-carrier uplink in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

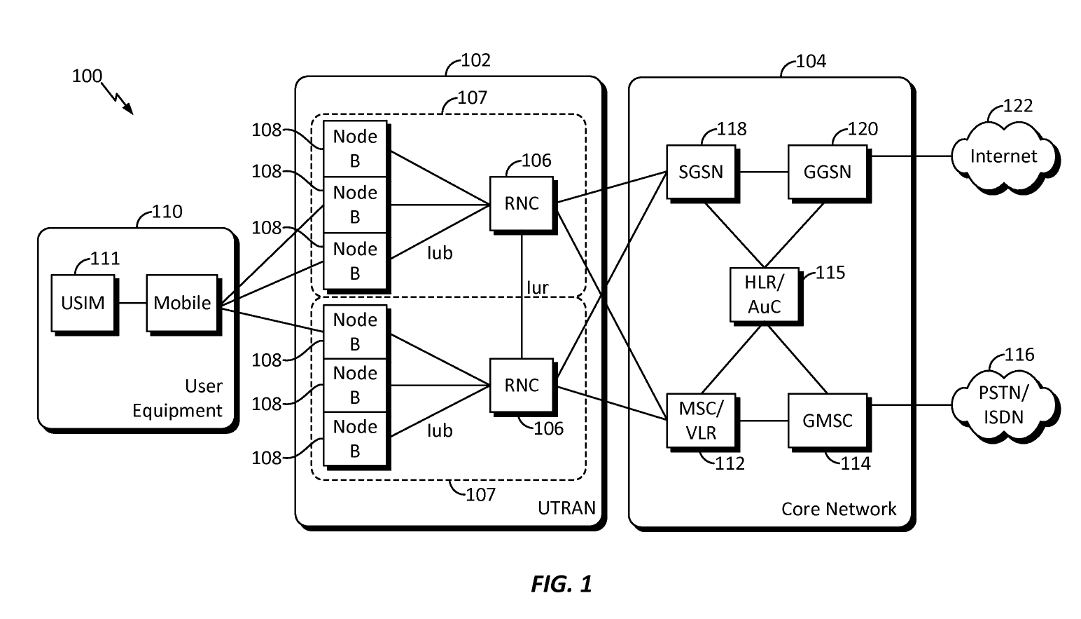

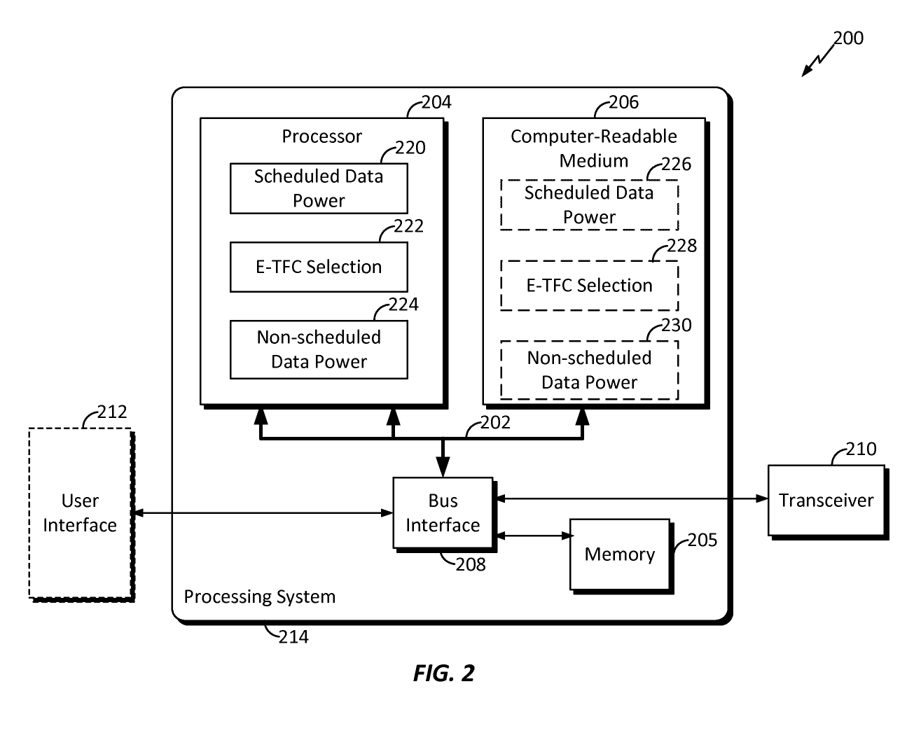

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a Universal Mobile Telecommunications System (UMTS) system 100. A UMTS network includes three interacting domains: a core network 104, a radio access network (RAN) (e.g., the UMTS Terrestrial Radio Access Network (UTRAN) 102), and a user equipment (UE) 110. The UE 110 may be any of the UEs illustrated in FIGS. 2-4 and/or 6. Among several options available for a UTRAN 102, in this example, the illustrated UTRAN 102 may employ a W-CDMA air interface for enabling various wireless services including telephony, video, data, messaging, broadcasts, and/or other services. The UTRAN 102 may include a plurality of Radio Network Subsystems (RNSs) such as an RNS 107, each controlled by a respective Radio Network Controller (RNC) such as an RNC 106. Here, the UTRAN 102 may include any number of RNCs 106 and RNSs 107 in addition to the illustrated RNCs 106 and RNSs 107. The RNC 106 is an apparatus responsible for, among other things, assigning, reconfiguring, and releasing radio resources within the RNS 107. The RNC 106 may be interconnected to other RNCs (not shown) in the UTRAN 102 through various types of interfaces such as a direct physical connection, a virtual network, or the like using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 108 are shown in each RNS 107; however, the RNSs 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smartwatch, a health or fitness tracker, etc.), an appliance, a sensor, a vending machine, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 110 may further include a universal subscriber identity module (USIM) 111, which contains a user's subscription information to a network. For illustrative purposes, one UE 110 is shown in communication with a number of the Node Bs 108. The downlink (DL), also called the forward link, refers to the communication link from a Node B 108 to a UE 110 and the uplink (UL), also called the reverse link, refers to the communication link from a UE 110 to a Node B 108. The UE 110 may aggregate two carriers or frequencies to support DC-HSUPA operations

The core network 104 can interface with one or more access networks, such as the UTRAN 102. As shown, the core network 104 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 104 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 104 supports circuit-switched services with a MSC 112 and a GMSC 114. In some applications, the GMSC 114 may be referred to as a media gateway (MGW). One or more RNCs, such as the RNC 106, may be connected to the MSC 112. The MSC 112 is an apparatus that controls call setup, call routing, and UE mobility functions. The MSC 112 also includes a visitor location register (VLR) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) 115 containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR 115 to determine the UE's location and forwards the call to the particular MSC serving that location.

The illustrated core network 104 also supports packet-switched data services with a serving GPRS support node (SGSN) 118 and a gateway GPRS support node (GGSN) 120. General Packet Radio Service (GPRS) is designed to provide packet-data services at speeds higher than those available with standard circuit-switched data services. The GGSN 120 provides a connection for the UTRAN 102 to a packet-based network 122. The packet-based network 122 may be the Internet, a private data network, or some other suitable packet-based network. The primary function of the GGSN 120 is to provide the UEs 110 with packet-based network connectivity. Data packets may be transferred between the GGSN 120 and the UEs 110 through the SGSN 118, which performs primarily the same functions in the packet-based domain as the MSC 112 performs in the circuit-switched domain.

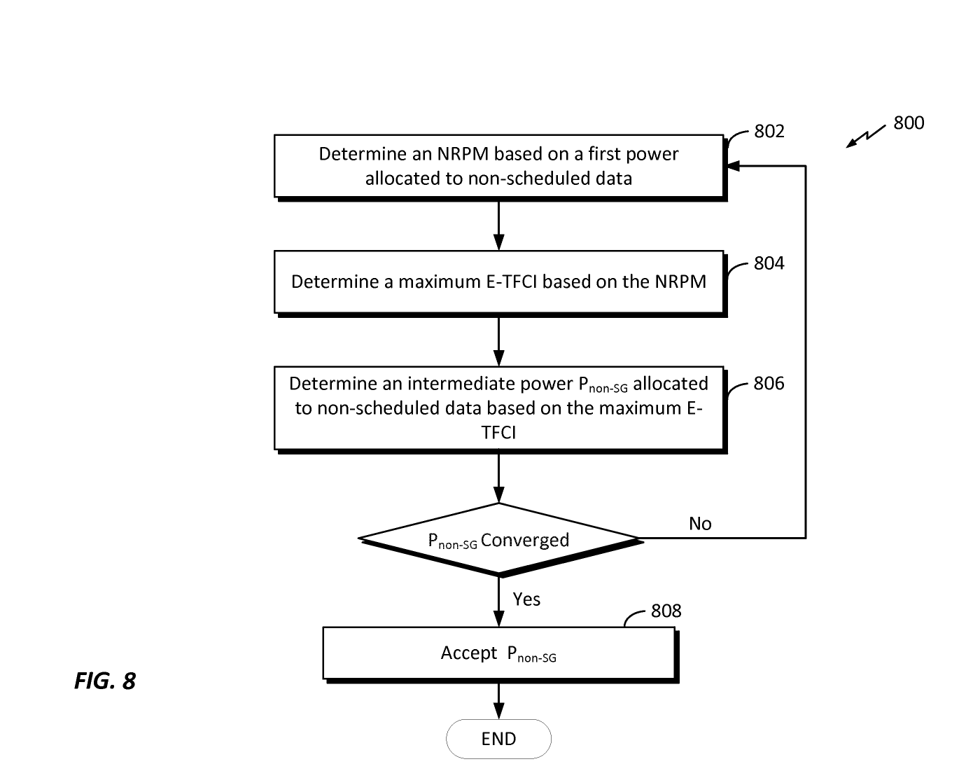

FIG. 2 is a diagram illustrating an example of a hardware implementation for an apparatus 200 employing a processing system 214. In accordance with various aspects of the disclosure, an element, or any portion of an element, or any combination of elements may be implemented with a processing system 214 that includes one or more processors 204. For example, the apparatus 200 may be a user equipment (UE) as illustrated in any one or more of FIGS. 1, 3, 4, and 6. In another example, the apparatus 200 may be a Node B or a radio network controller (RNC) as illustrated in any one or more of FIGS. 1, 3, 4, and 6. Examples of processors 204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 204, as utilized in an apparatus 200, may be used or configured to implement any one or more of the processes or procedures described below and illustrated for example in FIGS. 8-13.

In this example, the processing system 214 may be implemented with a bus architecture, represented generally by the bus 202. The bus 202 may include any number of interconnecting buses and bridges depending on the specific application of the processing system 214 and the overall design constraints. The bus 202 links together various circuits including one or more processors (represented generally by the processor 204), a memory 205, and computer-readable media (represented generally by the computer-readable medium 206). The bus 202 may also link various other circuits such as timing sources, peripherals, voltage regulators, and power management circuits, which are well known in the art, and therefore, will not be described any further. A bus interface 208 provides an interface between the bus 202 and a transceiver 210. The transceiver 210 is an example of a communication interface that provides a means for communicating with various other apparatus over a transmission medium. In some aspects of the disclosure, the transceiver 210 may include one or more transmitters and one or more receivers. The transmitters of the transceiver 210 may be configured to provide multiple uplinks. Each of the transmitters may include circuitry, for example, filters, buffers, mixers, modulators, and/or power amplifiers, which may be utilized to transmit various data types including scheduled data and non-scheduled data. The transceiver 210 may be configured based on various parameters including transport format combination, transmit power, traffic to pilot ratio (T/P), normalized remaining power margin (NRPM), and other suitable parameters. Depending upon the nature of the apparatus, a user interface 212 (e.g., keypad, display, speaker, microphone, joystick, touch screen, touch pad, touch sensor) may also be provided.

In various aspects of the disclosure, the processor 204 includes various components, modules, and/or blocks that can be configured to perform the functions and procedures illustrated in FIGS. 8-13. The various components, modules, and/or blocks of the processor 204 may be implemented as software, firmware, hardware, and/or a combination thereof. The processor 204 includes a scheduled data power block 220, an E-TFC selection block 222, and a non-scheduled data power block 224. The scheduled data power block 220 may be configured by a scheduled data power code 226 to perform various functions related to scheduled data power calculation and allocation. The E-TFC selection block 222 may be configured by an E-TFC selection code 228 to perform various functions related to EUL transport format combination (E-TFC) selection and E-TFCI/power offset determination. The non-scheduled data power block 224 may be configured by a non-scheduled data power code 230 to perform various functions related to non-scheduled data power calculation and allocation. These modules and codes will be described in more detail with an illustrative example below.

The processor 204 is responsible for managing the bus 202 and general processing, including the execution of software and codes stored on the computer-readable medium 206. The software, when executed by the processor 204, causes the processing system 214 to perform the various functions described below for any particular apparatus. The computer-readable medium 206 may also be used for storing data that is manipulated by the processor 204 when executing software.

One or more processors 204 in the processing system may execute software or be configured by software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 206. The computer-readable medium 206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 206 may reside in the processing system 214, external to the processing system 214, or distributed across multiple entities including the processing system 214. The computer-readable medium 206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

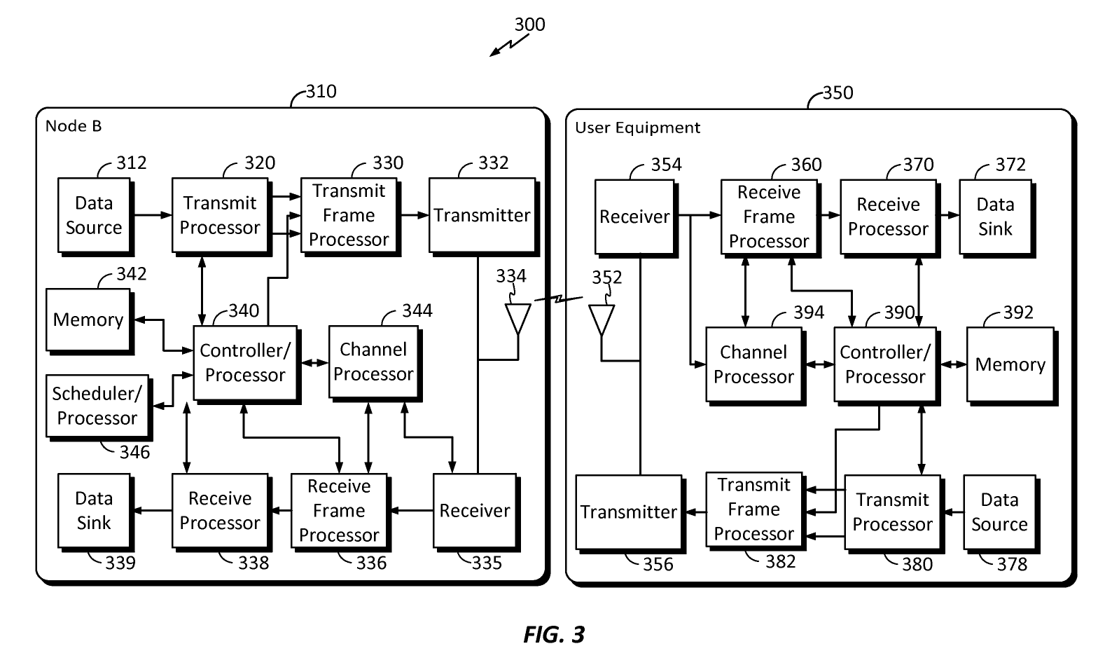

FIG. 3 is a block diagram of an exemplary Node B 310 in communication with an exemplary UE 350, where the Node B 310 may be any of the Node Bs illustrated in FIGS. 1, 2, 4, and 6, and the UE 350 may be any of the UEs illustrated in FIGS. 1, 2, 4, and 6. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback from the UE 350. The symbols generated by the transmit processor 320 are provided to a transmit frame processor 330 to create a frame structure. The transmit frame processor 330 creates this frame structure by multiplexing the symbols with information from the controller/processor 340, resulting in a series of frames. The frames are then provided to a transmitter 332, which provides various signal conditioning functions including amplifying, filtering, and modulating the frames onto a carrier for downlink transmission over the wireless medium through antenna 334. The antenna 334 may include one or more antennas, for example, including beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides information from the frames to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with information from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352. The transmitter 356 may include circuitry, for example, filters, buffers, mixers, modulators, and/or power amplifiers, which may be utilized to transmit various data types including scheduled data and non-scheduled data. The transmitter 356 may be configured based on various parameters including transport format combination, transmit power, traffic to pilot ratio (T/P), normalized remaining power margin (NRPM), and other suitable parameters.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides information from the frames to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

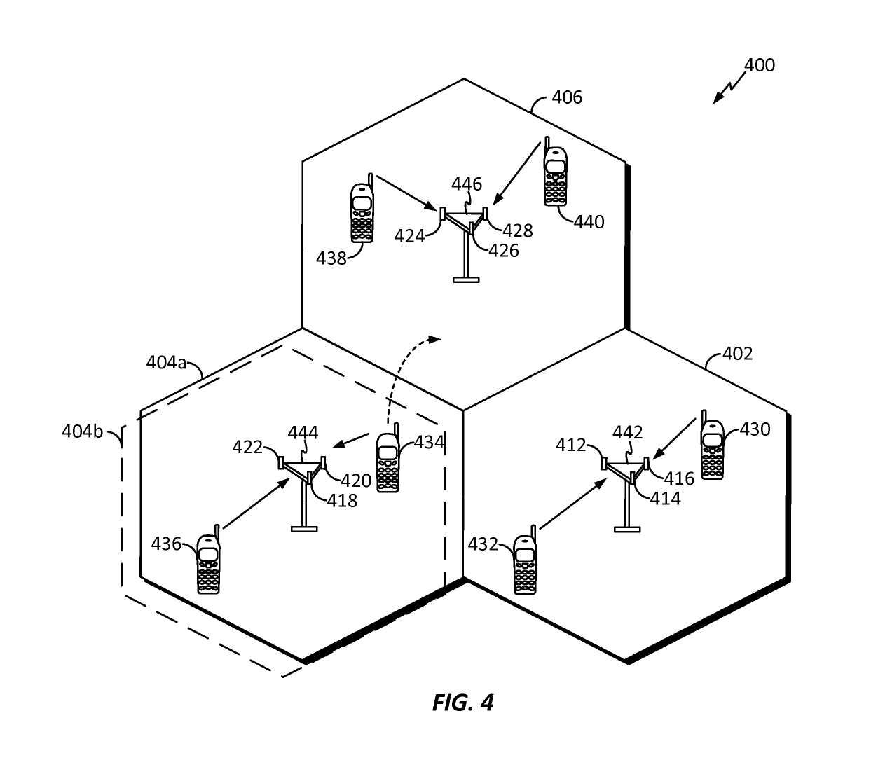

The UTRAN 102 (see FIG. 1) is one example of a RAN that may be utilized in accordance with the present disclosure. Referring to FIG. 4, by way of example and without limitation, a simplified schematic illustration of a RAN 400 in a UTRAN architecture is illustrated. The system includes multiple cellular regions (cells), including cells 402, 404, and 406, each of which may include one or more sectors. Cells may be defined geographically (e.g., by coverage area) and/or may be defined in accordance with a frequency, scrambling code, etc. That is, the illustrated geographically-defined cells 402, 404, and 406 may each be further divided into a plurality of cells, e.g., by utilizing different scrambling codes. For example, cell 404a may utilize a first scrambling code, and cell 404b, while in the same geographic region and served by the same Node B 444, may be distinguished by utilizing a second scrambling code.

In a cell that is divided into sectors, the multiple sectors within a cell can be formed by groups of antennas with each antenna responsible for communication with UEs in a portion of the cell. For example, in cell 402, antenna groups 412, 414, and 416 may each correspond to a different sector. In cell 404, antenna groups 418, 420, and 422 may each correspond to a different sector. In cell 406, antenna groups 424, 426, and 428 may each correspond to a different sector.

The cells 402, 404, and 406 may include several UEs that may be in communication with one or more sectors of each cell 402, 404, or 406 utilizing one or more carriers or frequencies. The UEs may be any of the UEs illustrated in FIGS. 1-4 and 6. For example, UEs 430 and 432 may be in communication with Node B 442, UEs 434 and 436 may be in communication with Node B 444, and UEs 438 and 440 may be in communication with Node B 446. Here, each Node B 442, 444, and 446 may be configured to provide an access point to a core network 204 (see FIG. 2) for all the UEs 430, 432, 434, 436, 438, and 440 in the respective cells 402, 404, and 406. Any of the UEs illustrated in FIG. 4 may be configured to perform the DC-HSUPA operations of FIGS. 8-13.

During a call with a source cell, or at any other time, the UE 436 may monitor various parameters of the source cell as well as various parameters of neighboring cells. Further, depending on the quality of these parameters, the UE 436 may maintain communication with one or more of the neighboring cells. During this time, the UE 436 may maintain an Active Set, that is, a list of cells to which the UE 436 is simultaneously connected (i.e., the UTRAN cells that are currently assigning a downlink dedicated physical channel DPCH or fractional downlink dedicated physical channel F-DPCH to the UE 436 may constitute the Active Set).

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 108 and a UE 110. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

A high speed packet access (HSPA) air interface includes a series of enhancements to the 3G/W-CDMA air interface between the UE 110 and the UTRAN 102, facilitating greater throughput and reduced latency for users. Among other modifications over prior standards, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink or EUL).

3GPP Release 6 specifications introduced uplink enhancements referred to as Enhanced Uplink (EUL) or High Speed Uplink Packet Access (HSUPA). HSUPA utilizes as its transport channel the EUL Dedicated Channel (E-DCH). The E-DCH is transmitted in the uplink together with the Release 99 DCH. The control portion of the DCH, that is, the Dedicated Physical Control Channel (DPCCH), carries pilot bits and downlink power control commands on uplink transmissions. In the present disclosure, the DPCCH may be referred to as a control channel (e.g., a primary control channel) or a pilot channel (e.g., a primary pilot channel) in accordance with whether reference is being made to the channel's control aspects or its pilot aspects.

The E-DCH is implemented by physical channels including the E-DCH Dedicated Physical Data Channel (E-DPDCH) and the E-DCH Dedicated Physical Control Channel (E-DPCCH). In addition, HSUPA relies on additional physical channels including the E-DCH HARQ Indicator Channel (E-HICH), the E-DCH Absolute Grant Channel (E-AGCH), and the E-DCH Relative Grant Channel (E-RGCH).

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 110 and the core network 104 (referring to FIG. 1), and may include circuit switched and packet switched protocols. The AS provides the lower layers, for signaling between the UTRAN 102 and the UE 110, and may include a user plane and a control plane. Here, the user plane or data plane carries user traffic, while the control plane carries control information (i.e., signaling).

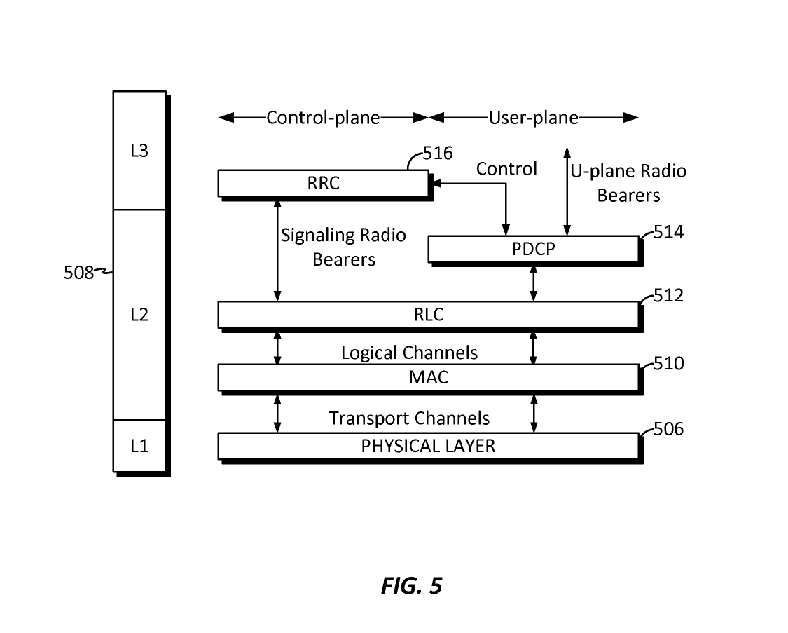

Turning to FIG. 5, the AS is shown with three layers: Layer 1, Layer 2, and Layer 3. Layer 1 is the lowest layer and implements various physical layer signal processing functions. Layer 1 will be referred to herein as the physical layer 506. The data link layer, called Layer 2 508, is above the physical layer 506 and is responsible for the link between the UE 110 and Node B 108 over the physical layer 506.

At Layer 3, the RRC layer 516 handles the control plane signaling between the UE 110 and the Node B 208. RRC layer 516 includes a number of functional entities for routing higher layer messages, handling broadcasting and paging functions, establishing and configuring radio bearers, etc.

In the illustrated air interface, the L2 layer 508 is split into sublayers. In the control plane, the L2 layer 508 includes two sublayers: a medium access control (MAC) sublayer 510 and a radio link control (RLC) sublayer 512. In the user plane, the L2 layer 508 additionally includes a packet data convergence protocol (PDCP) sublayer 514. Although not shown, the UE may have several upper layers above the L2 layer 508 including a network layer (e.g., IP layer) that is terminated at a PDN gateway on the network side and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between Node Bs.

The RLC sublayer 512 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

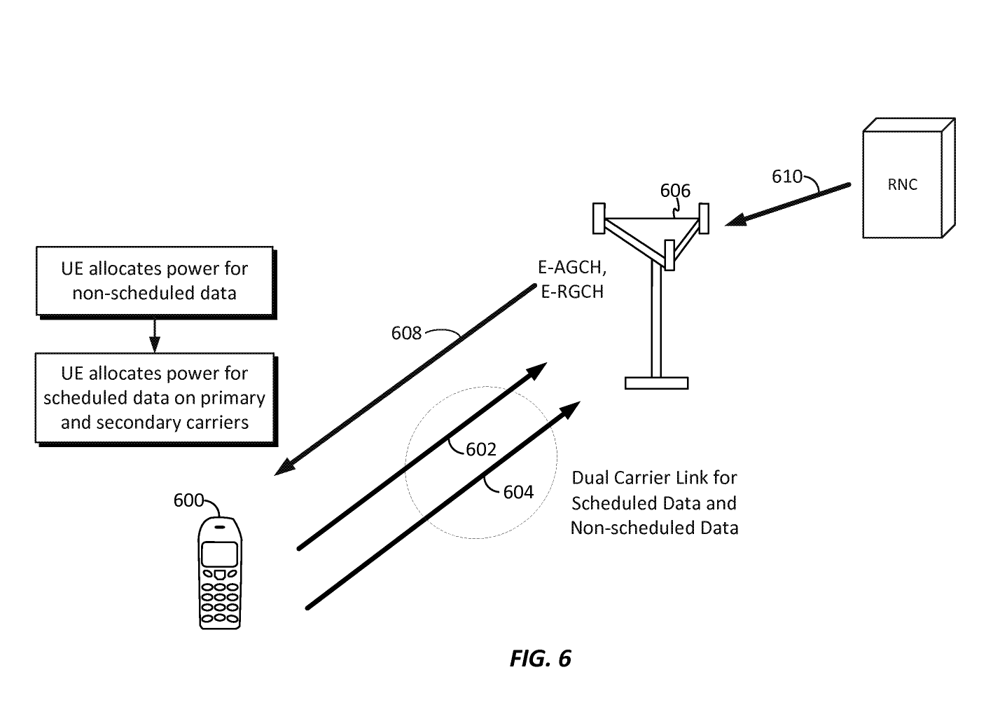

FIG. 6 is a diagram illustrating a UE 600 capable of performing multiple-carrier uplink communications in accordance with aspects of the disclosure. The UE 600 may be any of the UEs illustrated in FIGS. 1-4 or any suitable device. The UE 600 can utilize two or more multi-carrier uplinks, flows or carriers (602 and 604) to communicate with the same cell (e.g., Node B 606) to increase the uplink data rates. For example, the multiple-carrier uplinks may be DC-HSUPA carriers. The UE may utilize the HSUPA carriers (602 and 604) to transmit various data types to the Node B. In some aspects of the disclosure, the data types include scheduled data and non-scheduled data. In some other aspects of the disclosure, the data types may include other suitable uplink data. The Node B 606 may be a Node B illustrated in any of FIGS. 1-4. DC-HSUPA was introduced in Release 9 of the 3GPP standards to boost user uplink performance. It allows the UE 600 to make use of the instantaneous spare capacity available on either carrier, thus achieving multiplexing gain and load balancing. The benefit is a significant efficiency improvement which leads to higher system capacity. DC-HSUPA combines two uplink carriers (carrier aggregation) into a larger data pipe with joint scheduling of uplink traffic across the two carriers. DC-HSUPA provides for an E-DCH to be transmitted on each of a primary carrier and a secondary carrier. That is, in various aspects of the disclosure, the carrier corresponding to a primary transceiver chain may be referred to as a primary carrier (e.g., carrier 602), and the carrier corresponding to a secondary transceiver chain may be referred to as a secondary carrier (e.g., carrier 604). The present disclosure is not limited to only DC-HSUPA applications. In other aspects of the present disclosure, the UE 600 may utilize more than two uplink carriers or frequencies to communicate with the same cell to increase uplink data rates or bandwidth. In some examples, the present disclosure may be extended to Multi-carrier HSUPA (MC-HSUPA).

In DC-HSUPA, a scheduler at the Node B 606 may provide scheduling information to the UE 600 for transmission of scheduled flow or data for each uplink carrier. The UE requests a permission to send data, and the scheduler decides or grants when the UE will be allowed to do so. This scheduling information provided to the UE 600 may be utilized to schedule resources for the UE's uplink transmission. The scheduling of a UE may be made in accordance with various measurements made or determined by the Node B such as the noise level at the Node B receiver, with various feedback information transmitted on the uplink by UEs such as a “happy bit,” buffer status, and transmission power availability, and with priorities or other control information provided by the network. That is, the scheduler at the Node B may generate and transmit two grants 608, e.g., one for each carrier (primary and secondary carriers) during each transmission time interval (TTI) or a suitable interval.

For example, the E-AGCH is a physical channel that may be utilized to carry information from the Node B 606 to the UE 600 for controlling the power and transmission rate of uplink transmissions by the UE 600 on the E-DCH. Further scheduling information may also be conveyed from the Node B 606 to the UE 600 over the E-RGCH. Here, the E-RGCH may be utilized for small adjustments during ongoing data transmissions.

The grant provided on the E-AGCH can change over time for a particular UE, so grants may be periodically or intermittently transmitted by the Node B. The absolute grant value carried on the E-AGCH may indicate the maximum E-DCH traffic to pilot power ratio (T/P) (a transmit power parameter) that the UE 600 is allowed to use in its next transmission or TTI.

The scheduling grant 608 provided on the E-AGCH can be used by the UE 600 to determine at least the transport block size (TBS) for the primary and secondary carriers 602 and 604 to be transmitted in the next uplink transmission, as well as the transmit power on the E-DPDCH(s). The TBS is the size of a block of information transmitted on a transport channel (e.g., the E-DCH) during a TTI. The UE selects a certain transport format (number of bits to be transmitted in a TTI) in the EUL transport format combination (E-TFC) selection procedure. The UE transmits an E-DCH Transport Format Combination Indicator (E-TFCI) to the Node B via the E-DPCCH. The E-TFCI is a 7-bit value that indicates the selected E-TFC.

A further characteristic of DC-HSUPA is that during the EUL transport format combination (E-TFC) selection procedure, when building protocol data units (PDUs) for transmission of scheduled data, the secondary carrier may be considered before the primary carrier. That is, if the secondary carrier has available power and has received a grant for scheduled data, then any scheduled data that the UE has ready for transmission is first allocated to the secondary carrier, and afterward, remaining scheduled data is allocated to the primary carrier. However, the actual number of bits the UE is allowed to transmit on the secondary carrier may not be equal to the total allowed bits. Rather, the actual number of bits may correspond to the closest EUL transport format combination indicator (E-TFCI) that the UE may utilize, with a number of bits just below the total allowed bits.

Further, in the DC-HSUPA specifications, a “pre-allocation” of power for non-scheduled data or bits was introduced. For example, a non-scheduled flow may relate to guaranteed data, high priority control data, and/or high priority signaling data that the UE may send essentially whenever that data is ready to be sent. Non-scheduled data or a non-scheduled flow is self-initiated from the UE, and does not need to be scheduled by the Node B. In DC-HSUPA, according to 3GPP specifications, non-scheduled data is limited to transmissions on the primary uplink carrier. Unlike scheduled data, non-scheduled data need not be scheduled by the network on a TTI basis by utilizing channels such as the E-AGCH or E-RCGH. Rather, the amount of non-scheduled data that may be transmitted by the UE is pre-configured utilizing a more permanent grant 610 by the RNC, which is not influenced by the scheduler at the Node B 606.

Some non-scheduled data that typically utilizes a non-scheduled flow may include Signaling Radio Bearer (SRB), or voice-over-IP (VoIP) data. These types of data generally have limited tolerance for delay (e.g., time critical data) or low data rates, and thus, scheduling these types of data in scheduled flows might result in degradation of the user experience.

For a DC-HSUPA call, after allocating power from the transmission power for the non-scheduled transmission, the UE 600 estimates the remaining transmission power (remaining power) that is allocated for transmission of scheduled data on the primary carrier (e.g., carrier 602) and secondary carrier (e.g., carrier 604). For example, the UE may determine the power allocation as specified in 3GPP Technical Specification (TS) 25.133 Section 6.4 Release 12. In the calculation of the remaining power, the power pre-allocated for non-scheduled bits or data to be transmitted on the primary uplink frequency needs to be determined

According to the 3GPP standards, when the UE has more than one activated uplink frequency or carrier (e.g., DC-HSUPA), the UE estimates the remaining power (P_{remaining,s}) that is available to be allocated to scheduled E-DCH transmissions on all activated uplink frequencies or carriers. The total available power for scheduled E-DCH transmissions is defined by:

P_{remaining,s}=max(P_{Max}−Σᵢ P_{DPCCH,target,i}−P_{HS-DPCCH}−P_{non-SG}, 0) Equation (1)

P_{Max} represents the maximum UE transmitter power, as defined in 3GPP TS 25.133 Section 6.5. P_{DPCCH,i}(t) represents a slotwise estimate of the current UE DPCCH power for carrier with index i (e.g., i=0, 1) at time t. P_{DPCCH,target,i} refers to the DPCCH power for each uplink carrier. (e.g., i=0 for primary carrier and i=1 for secondary carrier). The terms P_{DPCCH,target,i} and P_{DPCCH,i}(t) may be used interchangeably throughout the specification. P_{HS-DPCCH} represents the estimated HS-DPCCH transmit power and is calculated based on the estimated primary activated frequency DPCCH power, and the greatest HS-DPCCH gain factor. P_{non-SG} represents the power pre-allocated for non-scheduled data for the primary uplink. An estimate of the E-DPCCH power used for non-scheduled transmissions may be included in P_{non-SG}.

In general, when the UE has more than one activated uplink frequency (or carrier), the UE may determine a transmit power parameter for facilitating the E-TFC selection of the uplink. One example of the transmit power parameter is T/P, which will be described in more detail below. Another example of the transmit power parameter is the normalized remaining power margin (NRPM) available for E-TFC selection using the power allocated to the primary uplink frequency P_{allocated,1} and the power allocated to the secondary uplink frequency P_{allocated,2} defined by:

P_{allocated,1}=P₁+P_{non-SG},

P_{allocated,2}=P₂

Pᵢ represents the maximum remaining allowed power for scheduled transmissions for the activated uplink frequency i=1, 2, where index 1 and index 2 correspond to the index of the primary uplink frequency (carrier) and the index of the secondary uplink frequency (carrier). The UE can calculate the NRPM based on the power of the DPCCH, the dedicated physical data channel (DPDCH), the high speed dedicated physical control channel (HS-DPCCH), and the E-DCH dedicated physical control channel (E-DPCCH). In one example, when the UE has more than one activated uplink frequency, the UE can estimate or calculate the NRPM available for E-TFC selection for the activated uplink frequency i based on the following equation for E-TFC candidate j:

NRPM_{i,j}=(P_{allocated, i}−P_{E-DPCCH,i,j})/P_{DPCCH, target,i} Equation (2)

The determined NRPM may be the maximum possible T/P or Traffic-to-Pilot ratio for the upcoming transmission. Therefore, for a certain NRPM, the maximum possible T/P is known and may be used for determining E-TFCI selection. P_{E-DPCCH,j,i} represents the estimated E-DPCCH transmit power for E-TFCIⱼ (e.g., j is an integer between 1 and 127 inclusive) on the activated uplink frequency i. See 3GPP TS 25.133 Section 6.4 Release 12 for more detail.

The power allocation to a frequency (carrier) i, Pᵢ, is calculated as:

$${P}_{i} = {P}_{remaining , s} \frac{{P}_{DPCCH , target , i} {SG}_{i}}{{Σ}_{k} {P}_{DPCCH , target , k} {SG}_{k}} \qquad Equation ( 3 )$$

i=0 or 1; k=0 or 1.

P_{remaining,s} is the remaining power for scheduled data transmissions once the power for non-scheduled transmissions has been taken into account, P_{DPCCH,target,i} is the filtered DPCCH power and SGᵢ is the serving grant on frequency i.

For the primary uplink frequency or carrier, the maximum remaining power allowed for E-DCH transmission is the sum of the total power pre-allocated for all the non-empty non-scheduled MAC-d flows and the power Pᵢ allocated to the primary uplink frequency. For the secondary uplink frequency, the maximum remaining power allowed for E-DCH transmission is the power Pᵢ allocated for the secondary uplink frequency or carrier.

The UE can determine a T/P versus TBS mapping for each E-TFCI based on the reference E-TFCI and reference power offset information signaled by the network. In one aspect of the disclosure, the ratio T/P can be calculated as:

$${\sum }_{k} \frac{{β}_{ed , k}^{2}}{{β}_{c}^{2}} \qquad Equation ( 4 )$$

In equation (4), β_{ed,k} is the E-DPDCH channel gain factor for E-DPDCH channel k (k=0 . . . 3, up to four channels), and β_{c} is the DPCCH channel gain factor for the DPCCH channel. When the E-DPDCH power extrapolation formula is configured, let β_{ed,ref} denote the reference gain factor of the reference E-TFCI. Let L_{e,ref} denote the number of E-DPDCHs used for the reference E-TFCI, and L_{e,i} denote the number of E-DPDCHs used for the i-th E-TFCI. If spreading factor SF2 is used, L_{e,ref} and L_{e,i} are the equivalent number of physical channels assuming spreading factor SF4. Let K_{e,ref} denote the transport block size of the reference E-TFCI, and K_{e,i} denote the transport block size of the i-th E-TFCI, where the mapping between the E-TFCI and the E-DCH transport block size is defined in for example 3GPP TS 25.321. For the i-th E-TFCI, the temporary variable β_{ed,i,harq} can be then computed as:

$${β}_{ed , j , harq} = {β}_{ed , ref} \sqrt{\frac{{L}_{e , ref}}{{L}_{e , j}}} \sqrt{\frac{{K}_{e , j}}{{K}_{e , ref}}} \cdot {10}^{( \frac{{Δ}_{harq}}{20} )} \qquad Equation ( 5 )$$

In equation (5), j corresponds to the E-TFCI for which β_{ed} is being calculated.

In equation (5), A_{ed,ref} may be signaled by the network for each reference E-TFCI, and the HARQ offsets A_{harq} to be used for support of different HARQ profile are configured by the higher layers. The variable β_{ed,i,harq} is the gain factor used for the E-DPDCH channel during data transmission.

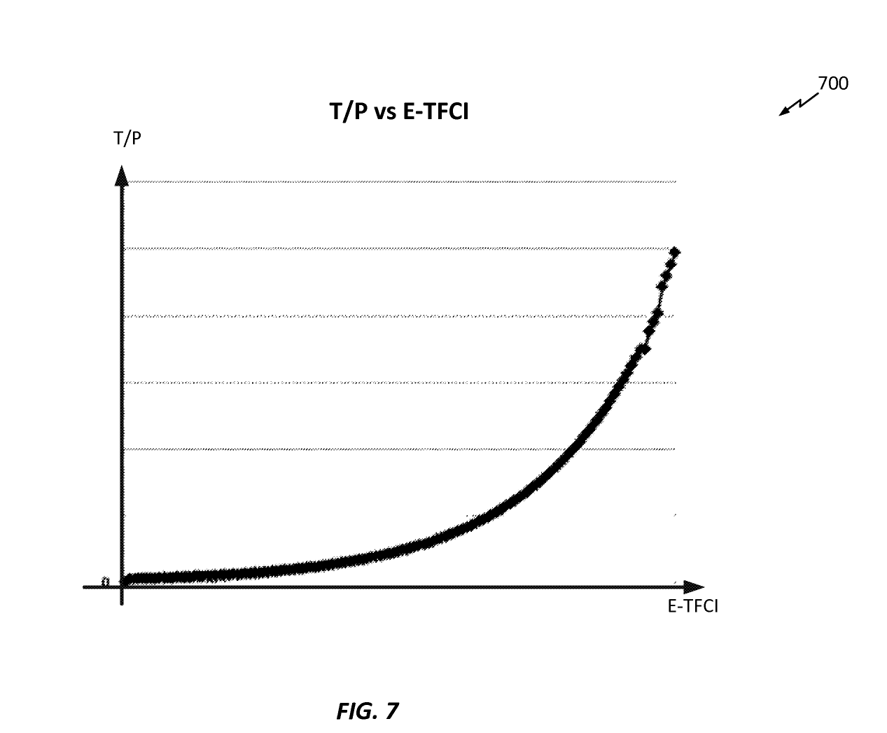

For DC HSUPA power allocation calculations, however, the current 3GPP standards do not specify which E-TFCI is used as a reference E-TFCI to calculate power corresponding to non-scheduled bits or data. FIG. 7 is a diagram illustrating an example of the relationship between the parameters T/P and E-TFCI. Because the parameters T/P and E-TFCI have a non-linear relationship, the same number of bits in a transport block size may be mapped to different values of T/P when using different E-TFCIs as reference. Non-scheduled data or bits are typically a small number, e.g., 144 bits or less. For example, if the UE uses E-TFCI=0 as a reference for calculating P_{non-SG}, then the power corresponding to non-scheduled bits will be insignificant when the total power headroom for E-DPDCH transmission is high, and the UE selects a higher E-TFCI for transmission on the primary carrier. This may affect the block error rate (BLER) when primary carrier has non-scheduled data for transmission in power limited scenarios.

On the other hand, if the highest possible E-TFCI on the primary carrier is used as a reference for calculating P_{non-SG}, then the power corresponding to non-scheduled bits or data may be too high, as T/P and TBS follow a non-linear relationship. This may limit the maximum E-TFCI that the UE can utilize to transmit on the primary carrier and may lower the overall throughput in power limited scenarios when in addition to scheduled data, the UE has non-scheduled data for transmission. For more information on E-TFCI selection, see 3GPP Technical Specification (TS) 25.321 Section 11.8.1.4 Release 12.

The reference E-TFCI power offsets, which are communicated to the UE at call setup, specify a set of E-TFCI and E-DPDCH/DPCCH power offset pairs. In HSPA, for example, there are 128 possible E-TFCI values, but the network typically signals a maximum of 8 E-TFCI/power offset pairs in the call setup signaling. These are known as the reference E-TFCIs. The UE may use an interpolation algorithm to determine the power offsets for the remaining E-TFCIs. However, for DC-HSUPA, no reference E-TFCI or power offsets are defined in the 3GPP specification for calculating the power corresponding to non-scheduled bits or data.

Aspects of the present disclosure provide for a method of determining the power pre-allocated for non-scheduled bits or data to improve UE performance. According to aspects of the disclosure, determining the optimal power pre-allocated for non-scheduled data can improve or increase (e.g., maximize) the allocation of remaining transmission power left for E-DCH transmission on the primary and/or secondary carriers, for example, in power-limited scenarios. Consequently, optimal power pre-allocated for non-scheduled data may lead to better E-TFCI selection on the primary and secondary carriers such that the block error rate (BLER) may be improved, and performance during dual E-DCH operations may be enhanced. Hence, the uplink throughput may be improved.

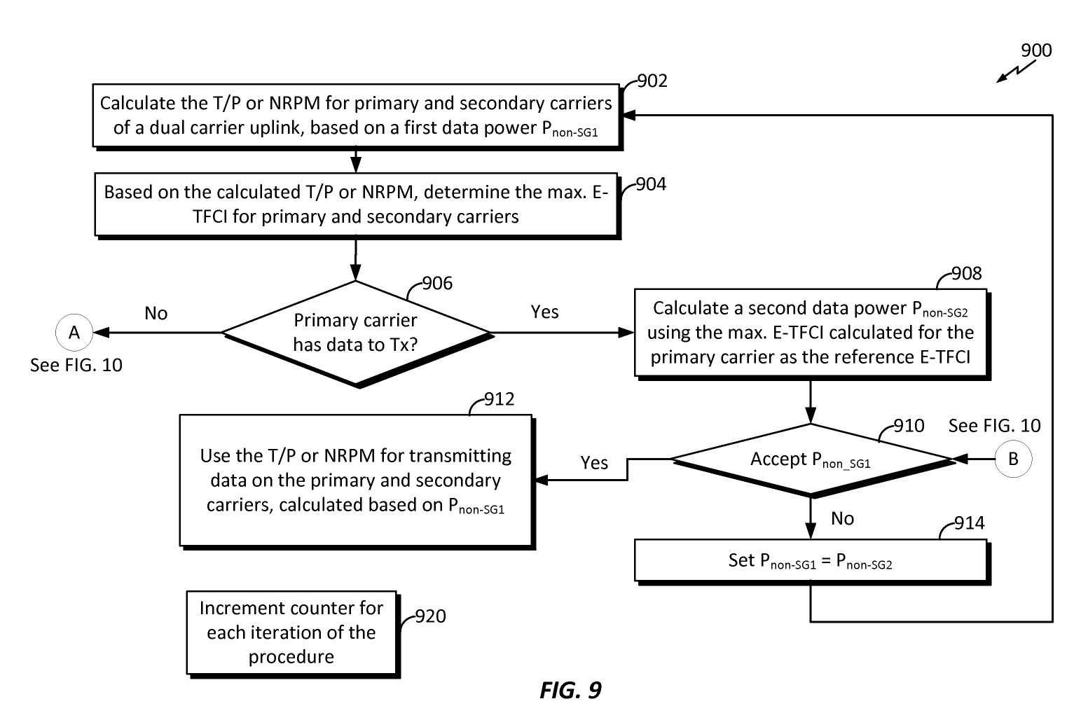

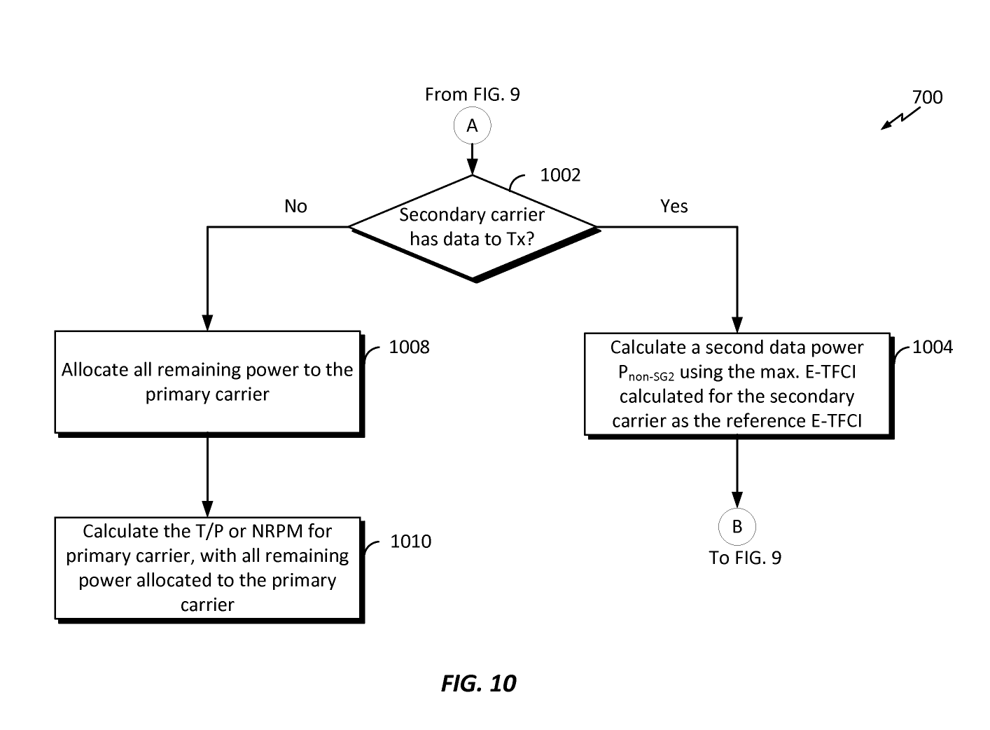

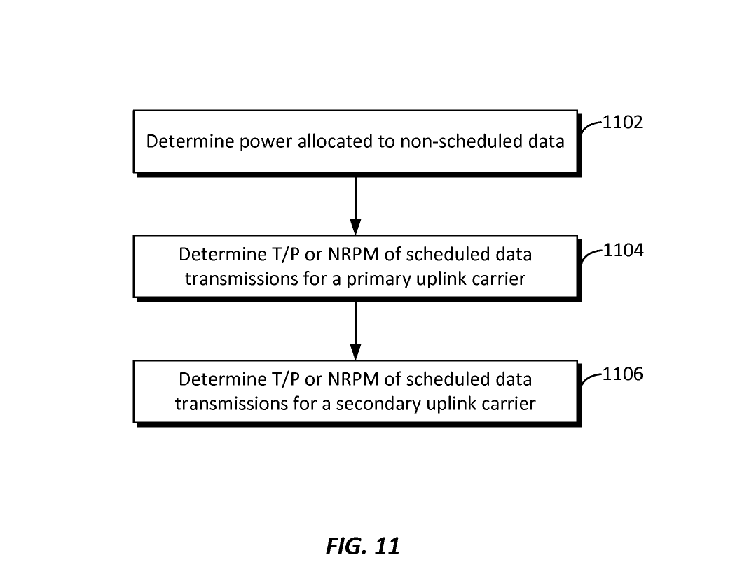

FIG. 8 is a flow chart illustrating a procedure 800 for iteratively determining the power allocation and E-TFCI selection for a dual-carrier uplink in accordance with an aspect of the disclosure. The procedure 800 may be performed by any of the UEs illustrated in FIGS. 1-4, and/or 6, or any suitable device. At block 802, a UE determines an intermediate NRPM (e.g., NRPM determined at block 1104 of FIG. 11) based on a first power allocated to non-scheduled data for a dual-carrier uplink (e.g., a DC-HSUPA uplink carriers 602 and 604 of FIG. 6). The first power allocated to the non-scheduled data may be set to zero initially. At block 804, the UE determines an intermediate E-TFCI (e.g., a maximum E-TFCI determined at block 904 of FIG. 9) based on the intermediate NRPM that is determined based on the first power (e.g., P_{non-SG1}. in FIGS. 9 and 10) allocated to non-scheduled data. At block 806, the UE determines a second power (e.g., P_{non-SG2}. in FIGS. 9 and 10) allocated to non-scheduled data based on the intermediate E-TFCI (e.g., maximum E-TFCI). This process is iterated until the value of power allocated to the non-scheduled data P_{non-SG} converges to a suitable value (e.g., a difference or comparison between P_{non-SG1} and P_{non-SG2} is less than a certain threshold), or a predetermined number of iterations are reached. In various aspects of the disclosure, utilizing the procedure of 800, the UE can determine a suitable power allocated to the non-scheduled data corresponding to the maximum or optimal E-TFCI for each carrier of a dual-carrier uplink.

An application of the procedure 800 in a DC-HSUPA example is described below in relation to FIGS. 9-13. FIGS. 9-13 illustrate a flow chart of a procedure 900 for determining the power allocation and E-TFCI selection on primary and secondary DC-HSUPA carriers when non-scheduled data are transmitted in accordance with aspects of the disclosure. The procedure 900 may be performed by any of the UEs illustrated in FIGS. 1-4 and/or 6, or any suitable device. In one example, the procedure 900 may be performed as part of a TTI power allocation algorithm for DC-HSUPA primary and secondary carriers. The DC-HSUPA primary and secondary carriers may carry various data types including scheduled data and non-scheduled data.

In the following description of the procedure 900, it is assumed that non-scheduled data are available to be transmitted on a primary carrier of a DC-HSUPA dual-carrier update. At block 902, the UE may utilize a scheduled data power block 220 to determine or calculate the T/P or NRPM of scheduled data transmissions for both uplink frequencies (primary and secondary carriers) based on a first data power P_{non-SG1} allocated for the non-scheduled data (e.g., a first data type) to be transmitted on the dual-carrier uplink utilizing, for example, a transceiver 210 (FIG. 2). In one example illustrated in FIG. 11, at block 1102, the UE determines the power (e.g., the first data power P_{non-SG1}) allocated to non-scheduled data. The first data power may be a variable stored in the computer-readable media 206 and set to 0 initially (e.g., P_{non-SG1}=0). At block 1104, the UE determines the T/P or NRPM of scheduled data transmissions (if available) for the primary uplink carrier. At block 1106, the UE determines the T/P or NRPM of scheduled data transmissions (if available) for the secondary uplink carrier. In one example, the UE may utilize the equation (2) described above to determine the T/P or NRPM at blocks 1104 and 1106 of FIG. 11. For example, the UE may configure the transmit power of its transceiver (e.g., transceiver 210 of FIG. 2) based on the determined T/P or NRPM.

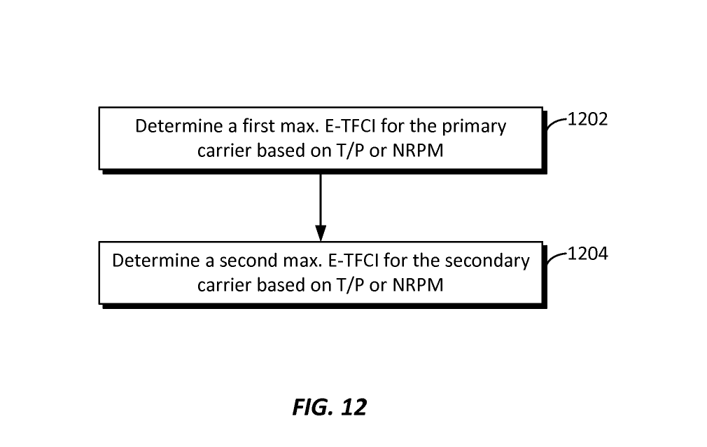

Referring back to FIG. 9, at block 904, based on the calculated T/P or NRPM of block 902, the UE may utilize a transport format selector (e.g., an E-TFC selection block 222) to determine the corresponding maximum E-TFCI (e.g., primary maximum E-TFCI and secondary maximum E-TFCI) for scheduled data transmissions on the primary carrier and secondary carrier, respectively. For example, the UE may configure its transceiver (e.g., transceiver 210 of FIG. 2) based on the determined E-TFCI. The maximum E-TFCI corresponding to the calculated T/P or NRPM for scheduled data transmissions for the primary carrier can be used as a reference E-TFCI for calculating the power to be pre-allocated for non-scheduled data transmission on the primary carrier. In one example illustrated in FIG. 12, at block 1202, the UE determines a first maximum E-TFCI for the primary carrier based on the calculated T/P or NRPM of the primary carrier. At block 1204, the UE determines a second maximum E-TFCI for the second carrier based on the calculated T/P or NRPM of the secondary carrier. In one aspect of the disclosure, the UE may utilize the relationship between the E-TFCI and T/P for example as illustrated in FIG. 7 or in a table stored in the computer-readable medium 206 to determine the maximum E-TFCI based on the T/P or NRPM.

At decision block 906, if the UE has scheduled data for transmission on the primary carrier, the procedure 900 proceeds to block 908; otherwise, the procedure 900 proceeds to decision block 1002 of FIG. 10. At block 908, the UE may utilize the non-scheduled data power block 224 to calculate or determine a second data power P_{non-SG2} to be pre-allocated for the non-scheduled bits or data, utilizing the maximum E-TFCI calculated for the primary carrier (see block 904) as a reference. The second data power P_{non-SG2} may be a variable that is set to zero initially and stored in the computer-readable medium 206.

In one aspect of the disclosure, the power (P_non_sg) pre-allocated to non-scheduled data may be calculated as follows:

IF (max_E-TFCI+non_sq_bits<=E-TFCI_127)

P_non_sg=(T/P(max_E-TFCI+non_sg_bits)−T/P(max_E-TFCI))×PDPCCH_Primary

ELSE

P_non_sg=(T/P(max_E-TFCI)−T/P(max_E-TFCI−non_sg_bits))×PDPCCH_Primary

The term max_E-TFCI is the number of bits in the maximum E-TFCI, which may be used as a reference for the calculation of P_non_sg. For example, the max_E-TFCI may be calculated in block 804 of FIG. 8. The term non_sg_bits is the number of bits in the non-scheduled data for the upcoming transmission. The term T/P(x) is the traffic-to-pilot ratio for the transmission of “x” number of bits in the upcoming TTI. The term PDPCCH_Primary is the primary carrier UL DPCCH pilot power.

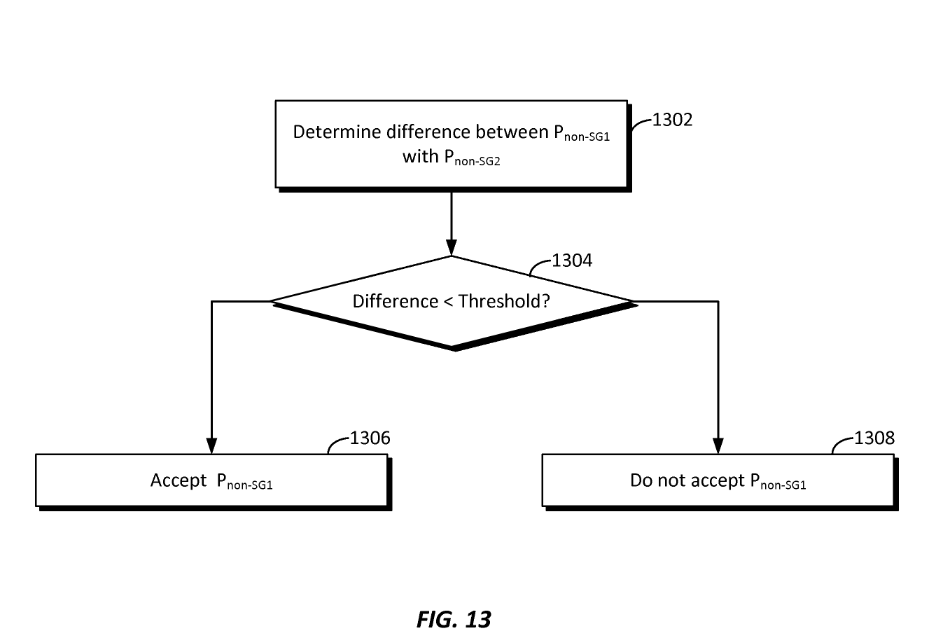

At decision block 910, the UE determines whether or not the first data power P_{non-SG1} has an acceptable value such that a suitable amount of power (e.g., optimal power) is allocated to the non-scheduled data transmission. In other words, the UE determines whether or not the values of the first data power and second data power converge to a certain threshold. In one example as illustrated in FIG. 13, at block 1302, the UE determines a difference in value between the first data power P_{non-SG1} and the second data power P_{non-SG2}. At decision block 1304, if the UE determines that the difference is less than or equal to a threshold value (e.g., a predetermined threshold), the UE may accept the first data power P_{non-SG1} at block 1306; otherwise, the UE does not accept the first data power P_{non-SG1} at block 1308. In one example, the threshold value may be zero. In one particular example, if the power P_{non-SG1} and the power P_{non-SG2} are equal in value, the first data power P_{non-SG1} is acceptable. In another example, if a difference in value between P_{non-SG1} and P_{non-SG2} is less than a certain non-zero threshold, the value of P_{non-SG1} is acceptable.

Referring back to FIG. 9, in one aspect of the disclosure, at block 920, the UE may increment a counter to determine when to stop after repeating the procedure 900 for a certain number of iterations, and accept the last calculated value of P_{non-SG1}. The incrementing counter may be stored in the computer-readable medium 206 and initially set to zero. If the value of P_{non-SG1} is accepted, the procedure 900 proceeds to block 912; otherwise; the procedure 900 proceeds to block 914. At block 914, the first data power P_{non-SG1} is set equal to the second data power P_{non-SG2}; then the procedure 900 repeats from the block 902.

At block 912, the UE may utilize the corresponding T/P or NRPM for transmitting data on the primary and secondary carriers, that is calculated based on the accepted first data power. Based on the T/P or NRPM determined in block 912, the UE may utilize the E-TFC selection block 222 to calculate or determine a suitable (e.g., maximum or optimal) E-TFCI for the primary and secondary carriers.

In the absence of scheduled data on the primary carrier, and if data is only scheduled on the secondary carrier (e.g., due to insufficient buffer or if there is no scheduled grant on the primary carrier), then the maximum E-TFCI corresponding to the above calculated NRPM (see block 804) for scheduled data transmissions for the secondary carrier can be used as a reference for calculating the power (e.g., optimal power) to be pre-allocated for non-scheduled data or bits.

At the decision block 906, if it is determined that the UE has no scheduled data for transmission on the primary carrier, the procedure 900 proceeds to the decision block 1002 (see FIG. 10). Referring to FIG. 10, at the decision block 1002, if the UE has scheduled data for transmission on the secondary carrier; the procedure 900 proceeds to block 1004. At block 1004, the UE may utilize the non-scheduled data power block 224 to determine or calculate a second data power P_{non-SG2} utilizing the maximum E-TFCI (see block 904) calculated for the secondary carrier as the reference E-TFCI. Then, the procedure 900 returns to the decision block 910 of FIG. 9.

At the decision block 1002, if the UE has no scheduled data for transmission on the primary and secondary carriers, the procedure 900 proceeds to block 1008. At block 1008, the UE may allocate all the remaining power (i.e., transmission power minus power pre-allocated to the non-scheduled data) to the primary carrier. At block 1010, the UE calculates or determines the T/P or NRPM for the primary carrier, with all the remaining power allocated to the primary carrier. Then, based on the determined T/P or NRPM, the UE can determine the E-TFCI (e.g., maximum or optimal E-TFCI) for the primary and secondary carriers.

As illustrated above in FIGS. 10-13, the UE determines an intermediate maximum E-TFCI (e.g., maximum E-TFCI determined at block 904) corresponding to an NRPM that is determined using an intermediate P_{non-SG}. (e.g., P_{non-SG1}. in FIGS. 9 and 10). This process is iterated until the value of intermediate P_{non-SG} converges to a suitable value (e.g., P_{non-SG1}=P_{non-SG2}), or a predetermined number of iterations are reached. In various aspects of the disclosure, utilizing the procedure of 900, the UE can allocate a suitable power (e.g., optimal power) to the non-scheduled data corresponding to the maximum or optimal E-TFCI for each carrier.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches an object B, and an object B touches an object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for operating a user equipment (UE) to determine power allocation for a multi-carrier uplink in wireless communication, comprising:
determining a first transmit power parameter for a primary carrier and a secondary carrier of a multi-carrier uplink, based on a first data power allocated for a first data type to be transmitted on the multi-carrier uplink;
determining a first maximum enhanced uplink transport format combination indicator (E-TFCI) for the primary carrier and the secondary carrier based on the first transmit power parameter; and
if the primary carrier or the secondary carrier has data of a second data type for transmission,
determining a second data power allocated for the first data type utilizing the first maximum E-TFCI as a reference E-TFCI; and
if a difference in value between the first data power and the second data power is less than a threshold value, utilizing the first transmit power parameter for transmitting data on the primary carrier and the secondary carrier.

2. The method of claim 1, wherein the determining the second data power comprises iteratively determining the second data power based on a comparison between the second data power and the first data power.

3. The method of claim 1, wherein the first transmit power parameter comprises a traffic to pilot power ratio (T/P) or a normalized remaining power margin (NRPM).

4. The method of claim 1, further comprising:
if both the primary carrier and the secondary carrier have no data of the second data type for transmission, allocating remaining power to the primary carrier, wherein the remaining power is determined by subtracting the first data power from a transmission power of the UE.

5. The method of claim 1,
wherein the first data type comprises non-scheduled data comprising at least one of Signaling Radio Bearer (SRB) data or voice-over-IP (VoIP) data, and
wherein the second data type comprises scheduled data.

6. An apparatus for wireless communication, comprising:
means for determining a first transmit power parameter for a primary carrier and a secondary carrier of a multi-carrier uplink, based on a first data power allocated for a first data type to be transmitted on the multi-carrier uplink;
means for determining a first maximum enhanced uplink transport format combination indicator (E-TFCI) for the primary carrier and the secondary carrier based on the first transmit power parameter; and
means for if the primary carrier or the secondary carrier has data of a second data type for transmission,
determining a second data power allocated for the first data type utilizing the first maximum E-TFCI as a reference E-TFCI; and
means for if a difference in value between the first data power and the second data power is less than a threshold value, utilizing the first transmit power parameter for transmitting data on the primary carrier and the secondary carrier.

7. The apparatus of claim 6, wherein the means for determining the second data power is configured to iteratively determine the second data power based on a comparison between the second data power and the first data power.

8. The apparatus of claim 6, wherein the first transmit power parameter comprises a traffic to pilot power ratio (T/P) or a normalized remaining power margin (NRPM).

9. The apparatus of claim 6, further comprising:
means for if both the primary carrier and the secondary carrier have no data of the second data type for transmission, allocating remaining power to the primary carrier, wherein the remaining power is determined by subtracting the first data power from a transmission power of the apparatus.

10. The apparatus of claim 6,
wherein the first data type comprises non-scheduled data comprising at least one of Signaling Radio Bearer (SRB) data or voice-over-IP (VoIP) data, and
wherein the second data type comprises scheduled data.

11. An apparatus for wireless communication, comprising:
a communication interface configured to utilize a multi-carrier uplink comprising a primary carrier and a secondary carrier;
a memory comprising code for allocating power to the multi-carrier uplink; and
at least one processor operatively coupled to the communication interface and the memory,
wherein the at least one processor when configured by the code comprises:
a first data power block configured to determine a first transmit power parameter for a primary carrier and a secondary carrier of the multi-carrier uplink, based on a first data power allocated for a first data type to be transmitted on the multi-carrier uplink;
a transport format selector configured to determine a first maximum enhanced uplink transport format combination indicator (E-TFCI) for the primary carrier and the secondary carrier based on the first transmit power parameter; and
a second data power block configured to if the primary carrier or the secondary carrier has data of a second data type for transmission,
determine a second data power allocated for the first data type utilizing the first maximum E-TFCI as a reference E-TFCI; and
if a difference in value between the first data power and the second data power is less than a threshold value, utilize the first transmit power parameter for transmitting data on the primary carrier and the secondary carrier.

12. The apparatus of claim 11, wherein the second data power block is further configured to iteratively determine the second data power based on a comparison between the second data power and the first data power.

13. The apparatus of claim 11, wherein the first transmit power parameter comprises a traffic to pilot power ratio (T/P) or a normalized remaining power margin (NRPM).

14. The apparatus of claim 11, wherein the second data power block is further configured to:
if both the primary carrier and the secondary carrier have no data of the second data type for transmission, allocate remaining power to the primary carrier, wherein the remaining power is determined by subtracting the first data power from a transmission power of the apparatus.

15. The apparatus of claim 11, wherein the first data type comprises non-scheduled data comprising at least one of Signaling Radio Bearer (SRB) data or voice-over-IP (VoIP) data.
